(19) United States
(12) Patent Application Publication
(10) Pub. No.: US 2009/0228548 A1
(43) Pub. Date: Sep. 10, 2009

(54) CLIENT TERMINAL, CLIENT SERVER SYSTEM, DATA ACQUISITION METHOD, AND PROGRAM

(76) Inventor: Shinsuke Kakiya, Tokyo (JP)

Correspondence Address: NEC CORPORATION OF AMERICA, 6535 N. STATE HWY 161, IRVING, TX, 75039, US

(21) Appl. No.: 12/397,064

(22) Filed: Mar. 3, 2009

(30) Foreign Application Priority Data
Mar. 4, 2008 (JP) 53141/2008

(51) Int. Cl. G06F 15/16; G06F 15/167

(52) U.S. Cl. 709/203; 345/541

(57) ABSTRACT

The client terminal according to the present invention is connected to a server and comprises a display unit and an input unit of a virtual computer executed by software on the server, includes a storage unit which stores dump data of the client terminal, an information acquisition unit which acquires network information on transmission and reception between the server and the client terminal and stores it in the storage unit, and a dump control unit which instructs the server to acquire dump data of the virtual computer in response to a predetermined operation to the input unit, and transmits the dump data and the network information that are stored in the storage unit to the server.

This application is based upon and claims the benefit of priority from Japanese Patent Application No. 2008-053141, filed on Mar. 4, 2008, the disclosure of which is incorporated herein in its entirety by reference.

### TECHNICAL FIELD

The present invention relates to a client terminal, a client server system, a data acquisition method and a program.

### BACKGROUND ART

In recent years, a thin client system in which an application program is executed on a server and the application program on the server is operated by a client that is connected to the server via a network has been widely used.

In the thin client system, the server configures a virtual PC (Personal Computer) that is executed by software. The thin client is remotely connected to this virtual PC via a network. A user operates the virtual PC on the server via an input/output device of the thin client. The virtual PC executes a processing according to an operation content transmitted from the thin client and transmits screen information obtained as a result of the processing to the thin client. The thin client displays the screen information received from the virtual PC on a display device. Generally, the server configures a plurality of virtual PCs and the screen information obtained by each of the virtual PCs is transmitted to the corresponding thin client.

As mentioned above, in the thin client system, the thin client has only the minimum function required as a client but it can execute enough a desired processing by operating the virtual PC. Therefore, the thin client system has advantages in which price-reduction of the client can be achieved and information leakage can be prevented. Accordingly, the thin client system has been widely used in recent years.

Japanese Patent Application Laid-Open No. 2007-034687 discloses an invention for a thin client system in which a client terminal can perform a predetermined operation even when communication with the server is disconnected.

Japanese Patent Application Laid-Open No. 1997-81422 discloses an invention for a failure analysis system in which an investigation of the causes of the failure can be efficiently performed based on dump data outputted to a dump file when a failure occurs.

Japanese Patent Application Laid-Open No. 2006-178794 discloses an invention for a system in which log files, setting files and the like of a maintenance target device are saved into a service center side server by using a thin client.

Japanese Patent Application Laid-Open No. 2003-179541 discloses an invention for a mobile phone terminal failure notification system in which when a mobile phone terminal stops its operation due to a failure, information for failure analysis that is stored in the mobile phone terminal in advance is transmitted to a development engineer at the time of reboot for convenience of troubleshooting.

Japanese Patent Application Laid-Open No. 1999-259341 discloses an invention of a method in which when a failure is detected in a system including a plurality of PCs such as a server and a client, each application automatically outputs dump data and makes a copy of a necessary log file.

### SUMMARY

An exemplary object of the present invention is to provide a client terminal, a client server system, a data acquisition method and a program in which a user can appropriately specify a location at which a problem occurs when the problem occurs.

A client terminal which is connected to a server and includes a display unit and an input unit of a virtual computer executed by software on the server according to an exemplary aspect of the invention includes a storage unit which stores dump data of the client terminal, an information acquisition unit which acquires network information on transmission and reception between the server and the client terminal and stores it in the storage uni- and a dump control unit which instructs the server to acquire dump data of the virtual computer in response to a predetermined operation to the input unit, and transmits the dump data and the network information that are stored in the storage unit to the server.

A client server system which includes a server and a client terminal that is connected to the server and includes a display unit and an input unit of a virtual computer executed by software on the server according to an exemplary aspect of the invention, wherein the client terminal includes a first storage unit which stores dump data of the client terminal,

an information acquisition unit which acquires network information on transmission and reception between the server and the client terminal and stores it in the first storage unit, and a first dump control unit which instructs the server to acquire dump data of the virtual computer in response to a predetermined operation to the input unit, and transmits the dump data and the network information that are stored in the first storage unit to the server, and the server comprises a second dump control unit which acquires dump data of the virtual computer in response to the instruction from the client terminal, and a second storage unit which stores the dump data acquired by the second dump control unit, and the dump data and the network information that are received from the client terminal.

A data acquisition method used by a client terminal that is connected to a server and includes a display unit and an input unit of a virtual computer executed by software on the server according to an exemplary aspect of the invention includes storing dump data of the client terminal in a storage unit, acquiring network information on transmission and reception between the server and the client terminal and storing it in the storage unit, and instructing the server to acquire dump data of the virtual computer in response to a predetermined operation to the input unit, and transmitting the dump data and the network information that are stored in the storage unit to the server.

A computer program stored on a computer readable memory, the program being executed by a client terminal that is connected to a server and includes a display unit and an input unit of a virtual computer executed by software on the server according to an exemplary aspect of the invention includes, for causing the client terminal to execute the processes of storing dump data of the client terminal in a storage unit, acquiring network information on transmission and reception between the server and the client terminal and storing it in the storage unit, and instructing the server to acquire dump data of the virtual computer in response to a predetermined operation to the input unit, and transmitting the dump data and the network information that are stored in the storage unit to the server.

### BRIEF DESCRIPTION OF THE DRAWINGS

Exemplary features and advantages of the present invention will become apparent from the following detailed description when taken with the accompanying drawings in which:

FIG. 1 is a block diagram showing a configuration of a client server system according to an exemplary embodiment 1 of the present invention;

FIG. 2 is a flowchart showing a procedure by which a client server system according to an exemplary embodiment 1 of the present invention acquires a display history;

FIG. 3 is a flowchart showing a procedure by which a client server system according to an exemplary embodiment 1 of the present invention acquires dump data;

FIG. 4 is a flowchart showing a procedure by which a server collects screen information, network information and dump data; and

FIG. 5 is a block diagram showing a configuration of a client terminal according to an exemplary embodiment 2 of the present invention.

### EXEMPLARY EMBODIMENT

As mentioned above, in a thin client system, because a user can operate the virtual PC on the server via an input/output device of a thin client, the thin client is often taken out from an office or the like and used outside the office. For this reason, in an environment in which the user uses the thin client, no maintenance personnel is available usually. Accordingly, if a problem such as for example, an abnormal screen display or a delay of a screen display occurs when a user uses the thin client, the maintenance personnel cannot confirm the state of the screen actually. Moreover, in an evaluation environment, it is difficult for the maintenance personnel to reproduce the state in which the problem occurs and to confirm it.

The client server system described in Japanese Patent Application Laid-Open No. 1999-259341 mentioned above initiates a dump data collection tool at the timing at which an error occurs in a client side. As a result, not only the dump data of the client but also the dump data of the server are collected automatically.

If this technology is applied to the thin client system, the thin client system can acquire the dump data of the thin client and the dump data of the server when an error occurs.

When the above-mentioned problem such as an abnormal screen display or a delay of a screen display occurs on the thin client, the following causes are considered:

(a) a problem on an OS (Operating System) or an application of a virtual PC, or a problem specific to the virtual PC;

(b) a problem on the thin client; and

(c) a problem caused by a delay in a network or a lack of a bandwidth.

Because the thin client does not have an application, acquires screen information of the virtual PC via a network, and displays it on a screen, it is considered that the problem such as an abnormal screen display or a delay of a screen display is caused by a problem on a network.

Accordingly, as mentioned above, when an error occurs, it is difficult for a user to appropriately specify the location in the thin client system at which the problem occurs by only acquiring the dump data of the thin client and the dump data of the server when the error occurs. Accordingly, the present invention provides a client terminal, a client server system, a data acquisition method and a program in which a user can appropriately specify a location in a thin client system at which a problem occurs.

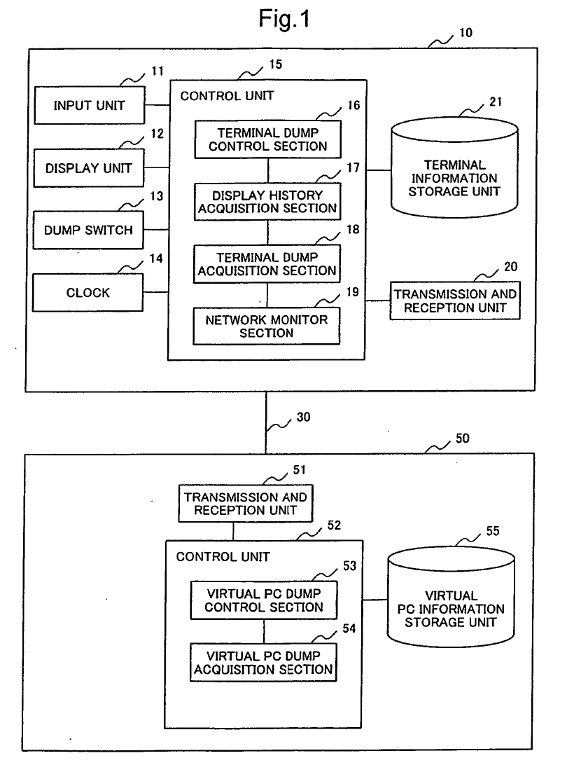

Next, a detailed explanation will be given for a first exemplary embodiment with reference to the drawings. FIG. 1 is a block diagram showing a configuration of a thin client system 100 according to an exemplary embodiment 1 of the present invention. As shown in FIG. 1, the thin client system 100 includes a thin client terminal 10 and a server 50. The server 50 configures a virtual computer (hereinafter, referred to as a virtual PC) that is executed by software. The thin client terminal 10 is connected with the virtual PC corresponding to oneself via a network 30 and operates the virtual PC according to user's operations. The server 50 may configure a plurality of virtual PCs other than the virtual PC corresponding to the thin client terminal 10.

The thin client terminal 10 includes an input unit 11, a display unit 12, a dump switch 13, a clock 14, a control unit 15, a transmission and reception unit 20 and a terminal information storage unit 21. The control unit 15 includes a terminal dump control section 16, a display history acquisition section 17, a terminal dump acquisition section 18 and a network monitor section 19.

The server 50 includes a transmission and reception unit 51, a control unit 52 and a virtual PC information storage unit 55. The control unit 52 includes a virtual PC dump control section 53 and a virtual PC dump acquisition section 54.

The input part 11 receives operations from a user. The display unit 12 displays information or the like to the user. When the user wants to acquire the dump data, the dump switch 13 is pushed down by the user and it instructs the control unit 15 to start to acquire the dump data. The terminal dump control section 16 controls a dump acquisition process in response to pushing down the dump switch 13. The display history acquisition section 17 acquires a history of a screen image displayed by the display unit 12 of the thin client terminal 10 and stores it in the terminal information storage unit 21. The terminal dump acquisition section 18 stores the dump data of the thin client terminal 10 in the terminal information storage unit 21 according to a control by the terminal dump control section 16. The network monitor section 19 always monitors the network 30 and acquires network information representing whether or not the network 30 transmits data properly. The network information includes for example, a total number of received data, a total number of transmission errors, a total number of transmission data, a total number of reception errors, and the like.

The transmission and reception unit 20 transmits/receives data to/from the server 50 via the network 30. The terminal information storage unit 21 stores terminal information on the thin client terminal 10, namely the dump data, screen information that is the history of the screen image of the display unit 12, network information, a display occurrence time and the like (detailed description will be given later).

The transmission and reception unit 51 of the server 50 transmits/receives data to/from the thin client terminal 10 via the network 30. When the virtual PC dump control section 53 receives an instruction to acquire dump data from the terminal dump control section 16 of the thin client terminal 10, it controls a dump data acquisition process of the server 50. The virtual PC dump acquisition section 54 stores the dump data of the virtual PC corresponding to the thin client terminal 10 in the virtual PC information storage unit 55 based on a control by the virtual PC dump control section 53. The virtual PC information storage unit 55 stores the terminal information on the thin client terminal 10 and the dump data on the virtual PC corresponding to the thin client terminal 10.

Next, operations of the thin client system 100 will be described.

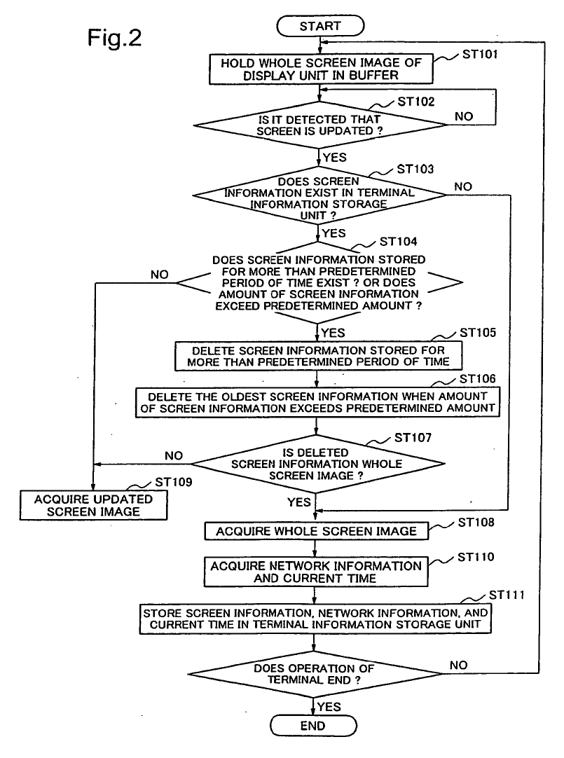

First, operations in which the thin client terminal 10 acquires the history of the screen display will be described. FIG. 2 is a flowchart showing a procedure by which the display history acquisition section 17 acquires the history of the screen display. Operations of the display history acquisition section 17 will be described with reference to this figure. Whenever the screen display displayed on the display unit 12 is updated, the display history acquisition section 17 acquires a screen image.

The display history acquisition section 17 holds a whole screen image which is currently displayed on the display unit 12 in a buffer (not illustrated) (step ST101). The display history acquisition section 17 always monitors whether or not the screen display on the display unit 12 is updated. When it is detected that the screen display on the display unit 12 is updated (“Yes” in step ST102), the display history acquisition section 17 checks whether or not screen information is stored in the terminal information storage unit 20 (step ST103). When the screen information is stored, the display history acquisition section 17 checks whether or not the screen information stored for more than a predetermined period of time exist and whether or not the amount of the screen information stored in the terminal information storage unit 21 exceeds a predetermined amount (step ST104). Here, as mentioned later, the screen information is stored together with the display occurrence time in the terminal information storage unit 21.

When the screen information stored for more than the predetermined period of time exists, the display history acquisition section 17 deletes it (step ST105). When the amount of the screen information stored in the terminal information storage unit 21 exceeds the predetermined amount, the display history acquisition section 17 deletes the screen information having the oldest display occurrence time (step ST106).

Next, the display history acquisition section 17 acquires the whole screen image currently displayed on the display unit 12 at the time when the following condition is met (step ST108). Specifically,
the screen information deleted in step ST105 or step ST106 is the whole screen image (“Yes” in step ST107), or
the image information is not stored in the terminal information storage unit 21 (“No” in step ST103).

On the other hand, the display history acquisition section 17 acquires the updated screen image when the following condition is met (step ST109).
The deleted screen information is not the whole screen image (“No” in step ST107), or
the screen information stored for more than the predetermined period of time does not exist in the terminal information storage unit 21, and the amount of the screen information stored in the terminal information storage unit 21 does not exceed the predetermined amount (“No” in step ST104).

Specifically, the display history acquisition section 17 compares a screen image displayed on the display unit 12 at that time with the screen information held in the buffer and acquires the screen image of a different part between them.

Next, the display history acquisition section 17 acquires network information that is monitored by the network monitor section 19 and acquires a current time that is the display occurrence time from the clock 14 (step ST110). As mentioned above, the network information includes for example, the total number of received data, the total number of transmission errors, the total number of transmission data and the total number of reception errors. Next, the display history acquisition section 17 stores the screen information, the network information and the display occurrence time that are acquired in the terminal information storage unit 21 (step ST111). The display history acquisition section 17 repeats the above mentioned processes until the operation of the thin client terminal 10 will end. By the above mentioned processes, the display history acquisition section 17 acquires the history of the screen image displayed on the display unit 12 and the history of the network information.

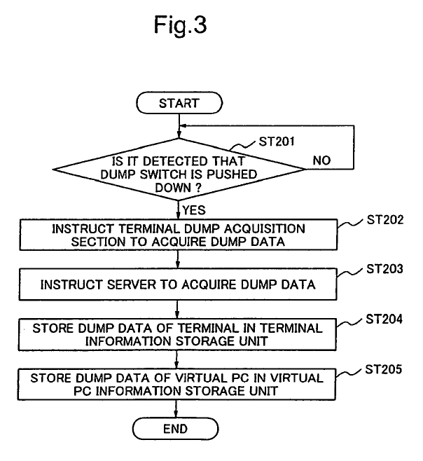

FIG. 3 is a flowchart showing operation of a dump acquisition process. The dump acquisition process will be described with reference to FIG. 3.

When a user wants to acquire the dump data, for example, at the time of error occurrence or the like, the user pushes down the dump switch 13. The terminal dump control section 16 always monitors whether or not the dump switch 13 is pushed down. When it is detected by the terminal dump control section 16 that the dump switch is pushed down (“Yes” in step ST201), the terminal dump control section 16 provides a signal to instruct the terminal dump acquisition section 18 to acquire the dump data of the thin client terminal 10 (step ST202). The terminal dump control section 16 provides a signal to instruct the server 50 to acquire the dump data of the virtual PC corresponding to the thin client terminal 10 (step ST203).

The terminal dump acquisition section 18 acquires the dump data of the thin client terminal 10 in response to the above instruction signal and stores the obtained data in the terminal information storage unit 21 (step ST204). When the server 50 receives the above mentioned instruction signal in the transmission and reception unit 51, the virtual PC dump control section 53 provides a signal to instruct the virtual PC dump acquisition section 54 to acquire the dump data of the virtual PC. The virtual PC dump acquisition section 54 acquires the dump data of the virtual PC in response to the instruction signal and stores the acquired data in the virtual PC information storage unit 55 (step ST205). By the above mentioned processes, the thin client terminal 10 and the virtual PC corresponding to it acquire the dump data.

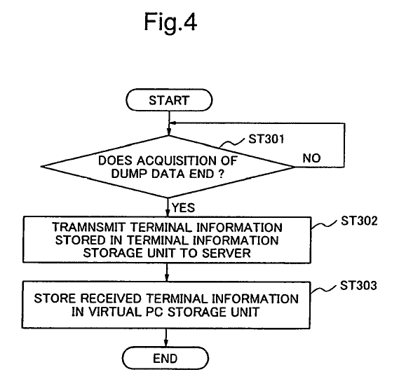

FIG. 4 is a flowchart showing a procedure by which the server 50 collects the screen information, the network information and the dump data that are acquired. The collection process performed by the server will be described with reference to FIG. 4.

When the terminal dump acquisition section 18 finishes the acquiring the dump data (“Yes” in step ST301), it notifies the terminal dump control section 16 of it. The terminal dump control section 16 transmits the terminal information stored in the terminal information storage unit 21, that are the dump data of the thin client terminal 10, the screen information stored up to that time, the network information and the display occurrence time to the server 50 via the transmission and reception unit 20 in response to the notification (step ST302).

The server 50 receives the above-mentioned terminal information in the transmission and reception unit 51. The virtual PC dump control section 53 stores the terminal information on the thin client terminal 10 which is received by the transmission and reception unit 51 in the virtual PC information storage unit 55 (step ST303). By the above mentioned processes, the server 50 collects the screen information, the network information and the dump data.

As mentioned above, in the thin client system 100 of the exemplary embodiment 1, the terminal dump acquisition section 18 of the thin client terminal 10 stores the dump data in the terminal information storage unit 21 in response to pushing down the dump switch 13. Whenever the screen display on the display unit 12 is updated, the display history acquisition section 17 acquires the screen information, the network information and the display occurrence time and stores them in the terminal information storage unit 21. When the acquisition of the dump data ends, the terminal dump control section 16 transmits the terminal information stored in the terminal information storage unit 21, that are the dump data of the thin client terminal 10, the screen information, the network information and the display occurrence time to the server 50.

In the server 50, the virtual PC dump acquisition section 54 stores the dump data of the virtual PC corresponding to the thin client terminal 10 in the virtual PC information storage unit 55 in response to the instruction from the thin client terminal 10. The virtual PC dump control section 53 stores the terminal information received from the thin client terminal 10 in the virtual PC information storage unit 55.

By the above mentioned operation, the thin client system 100 can store the dump data of the thin client terminal 10 and the dump data of the virtual PC when the problem occurs and the screen image of the thin client terminal 10, the network information, and the history of the display occurrence time up to the time when the problem occurs in the virtual PC information storage unit 55. By this configuration, the thin client system 100 can acquire the information about the situation of the thin client terminal 10, the situation of the virtual PC and the situation of the network 30 separately. When an abnormal condition occurs, a user refers to the dump data of the thin client terminal 10, the dump data of the virtual PC and the network information. When the user finds an abnormality of the dump data of the thin client terminal 10, the user can recognize that the occurring problem arises from the thin client terminal 10. When the user finds an abnormality of the dump data of the virtual PC, the user can recognize that the occurring problem arises from the virtual PC. When the user finds an abnormality of the network information, the user can recognize that the occurring problem is caused by the problem on the network.

Thus, the exemplary embodiment 1 of the present invention has an advantage in which the user can appropriately specify a location at which a problem occurs by analyzing the information stored in the virtual PC information storage unit 55.

The display history acquisition section 17 acquires the history of the screen display and the display occurrence time of the display unit 12 and stores them in the terminal information storage unit 21, and the terminal dump control section 16 transmits them to the server 50. The server 50 stores the history of the screen display and the display occurrence time that are received from the thin client terminal 10 in the virtual PC information storage unit 55. This configuration has an advantage in which the user can easily grasp phenomena such as an abnormal screen display or a delay which occurs in the thin client terminal 10 by checking the information stored in the virtual PC information storage unit 55.

### Exemplary Embodiment 2

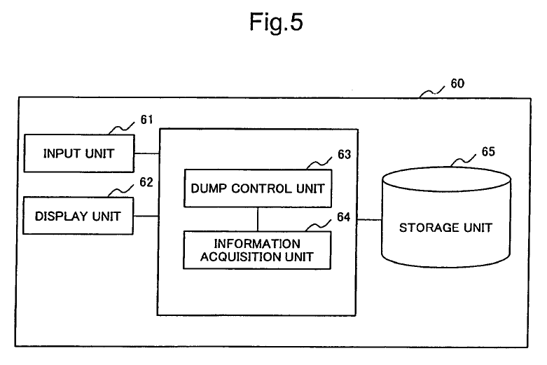

FIG. 5 is a block diagram showing a configuration of a client terminal 60 according to an exemplary embodiment 2 of the present invention. As shown in FIG. 5, the client terminal 60 includes an input unit 61, a display unit 62, a dump control unit 63, an information acquisition unit 64, and a storage unit 65. The input unit 61 and the display unit 62 are an input unit and a display unit of a virtual computer which is executed by software on a server connected to the client terminal 60, respectively.

The information acquisition unit 64 acquires the network information on transmission and reception between the server and the client terminal 60 and stores it in the storage unit 65. The dump control unit 63 instructs the server to acquire the dump data of the virtual computer in response to a predetermined operation to the input unit 61, and transmits the network information and the dump data that are stored in the storage unit 65 to the server.

By the above-mentioned configuration, the client terminal 60 by which the user can appropriately specify a location at which a problem occurs can be provided.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

What is claimed is:

1. A client terminal which is connected to a server and comprises a display unit and an input unit of a virtual computer executed by software on said server, comprising:
a storage unit which stores dump data of said client terminal;
an information acquisition unit which acquires network information on transmission and reception between said server and said client terminal and stores it in said storage unit; and
a dump control unit which instructs said server to acquire dump data of said virtual computer in response to a predetermined operation to said input unit, and transmits said dump data and said network information that are stored in said storage unit to said server.

2. The client terminal according to claim 1, wherein said information acquisition unit acquires screen information displayed on said display unit and stores it in said storage unit, and
said dump control unit transmits the screen information stored in said storage unit to said server.

3. The client terminal according to claim 2, wherein said information acquisition unit acquires a display occurrence time together with said screen information and stores them in said storage unit and
said dump control unit transmits the display occurrence time stored in said storage unit to said server.

4. The client terminal according to claim 2, wherein said information acquisition unit deletes the screen information that is stored for more than a predetermined period of time from said storage unit.

5. The client terminal according to claim 2, wherein said information acquisition unit deletes the oldest screen information when said screen information whose amount exceeds a predetermined amount is stored in said storage unit.

6. The client terminal according to claim 4, wherein said information acquisition unit acquires a whole screen image displayed on said display unit when said deleted screen information is the whole screen image displayed on said display unit, and acquires only the updated screen image when said deleted screen information is not the whole screen image displayed on said display unit.

7. A client server system which includes a server and a client terminal that is connected to said server and comprises a display unit and an input unit of a virtual computer executed by software on said server, wherein
said client terminal comprises
a first storage unit which stores dump data of said client terminal,
an information acquisition unit which acquires network information on transmission and reception between said server and said client terminal and stores it in said first storage unit, and
a first dump control unit which instructs said server to acquire dump data of said virtual computer in response to a predetermined operation to said input unit, and transmits said dump data and said network information that are stored in said first storage unit to said server; and
said server comprises
a second dump control unit which acquires dump data of said virtual computer in response to the instruction from said client terminal, and
a second storage unit which stores the dump data acquired by said second dump control unit, and said dump data and said network information that are received from said client terminal.

8. The client server system according to claim 7, wherein said information acquisition unit acquires screen information displayed on said display unit and stores it in said first storage unit, and
said first dump control unit transmits the screen information stored in said first storage unit to said server.

9. The client server system according to claim 8, wherein said information acquisition unit acquires a display occurrence time together with said screen information and stores them in said first storage unit and
said first dump control unit transmits the display occurrence time stored in said first storage unit to said server.

10. The client server system according to claim 8, wherein said information acquisition unit deletes the screen information that is stored for more than a predetermined period of time from said first storage unit.

11. The client server system according to claim 8, wherein said information acquisition unit deletes the oldest screen information when said screen information whose amount exceeds a predetermined amount is stored in said first storage unit.

12. The client server system according to claim 10, wherein said information acquisition unit acquires a whole screen image displayed on said display unit when said deleted screen information is the whole screen image displayed on said display unit, and acquires only the updated screen image when said deleted screen information is not the whole screen image displayed on said display unit.

13. A data acquisition method used by a client terminal that is connected to a server and includes a display unit and an input unit of a virtual computer executed by software on said server, comprising:
storing dump data of said client terminal in a storage unit;
acquiring network information on transmission and reception between said server and said client terminal and storing it in said storage unit; and
instructing said server to acquire dump data of said virtual computer in response to a predetermined operation to said input unit, and transmitting said dump data and said network information that are stored in said storage unit to said server.

14. The data acquisition method according to claim 13, which further comprises:
acquiring screen information displayed on said display unit and storing it in said storage unit; and
transmitting the screen information stored in said storage unit to said server.

15. The data acquisition method according to claim 14, wherein
said step of acquiring further acquires display occurrence time together with said screen information,
said step of storing further stores said display occurrence time in said storage unit, and
said step of transmitting further transmits said display occurrence time stored in said storage unit to said server.

16. The data acquisition method according to claim 14, which further comprises deleting the screen information that is stored for more than a predetermined period of time from said storage unit.

17. The data acquisition method according to claim 14, which further comprises deleting the oldest screen information when said screen information whose amount exceeds a predetermined amount is stored in said storage unit.

18. The data acquisition method according to claim 16, wherein said step of acquiring acquires a whole screen image displayed on a display unit when said deleted screen information is the whole screen image displayed on the display unit, and acquires only the updated screen image when the deleted screen information is not the whole screen image displayed on the display unit.

19. A computer program stored on a computer readable memory, said program being executed by a client terminal that is connected to a server and includes a display unit and an input unit of a virtual computer executed by software on said server, for causing said client terminal to execute the processes of:
storing dump data of said client terminal in a storage unit;
acquiring network information on transmission and reception between said server and said client terminal and storing it in said storage unit; and
instructing said server to acquire dump data of said virtual computer in response to a predetermined operation to said input unit, and transmitting said dump data and said network information that are stored in said storage unit to said server.

20. The program according to claim 19, which further comprises the processes of:
acquiring screen information displayed on said display unit and storing it in said storage unit; and
transmitting the screen information stored in said storage unit to said server.

21. The program according to claim 20, wherein
said process of acquiring further acquires display occurrence time together with said screen information,
said process of storing further stores said display occurrence time in said storage unit, and
said process of transmitting further transmits the display occurrence time stored in said storage unit to said server.

22. The program according to claim 20, which further comprises the process of deleting said screen information that is stored for more than a predetermined period of time from said storage unit.

23. The program according to claim 20, which further comprises the process of deleting the oldest screen information when said screen information whose amount exceeds a predetermined amount is stored in said storage unit.

24. The program according to claim 22, wherein said process of acquiring acquires a whole screen image displayed on a display unit when said deleted screen information is the whole screen image displayed on the display unit, and acquires only the updated screen image when the deleted screen information is not the whole screen image displayed on the display unit.

25. A client terminal which is connected to a server and comprises display means and input means of a virtual computer executed by software on said server comprising:
storage means for storing dump data of said client terminal;
information acquisition means for acquiring network information on transmission and reception between said server and said client terminal and storing it in said storage means; and
dump control means for instructing said server to acquire dump data of said virtual computer in response to a predetermined operation to said input means, and transmitting said dump data and said network information that are stored in said storage means to sa d server.

26. A client server system which includes a server and a client terminal that is connected to said server and comprises display means and input means of a virtual computer executed by software on said server, wherein
said client terminal comprises
first storage means for storing dump data of said client terminal,
information acquisition means for acquiring network information on transmission and reception between said server and said client terminal and storing it in said first storage means, and
first dump control means for instructing said server to acquire dump data of said virtual computer in response to a predetermined operation to said input means, and transmitting said dump data and said network information that are stored in said first storage means to said server and
said server comprises
second dump control means for acquiring dump data of said virtual computer in response to the instruction from said client terminal, and
second storage means for storing the dump data acquired by said second dump control means, and said dump data and said network information that are received from said client terminal.
